(19) United States
(12) Patent Application Publication
(10) Pub. No.: US 2019/0041875 A1
(43) Pub. Date: Feb. 7, 2019

(54) METHOD AND DEVICE FOR MONITORING THE POSITION OF A FOLLOWING AIRCRAFT WITH RESPECT TO A LEADING AIRCRAFT DURING A FORMATION FLIGHT

(71) Applicant: Airbus Operations (S.A.S.), Toulouse (FR)

(72) Inventors: José Torralba, Merville (FR); Jean-luc Robin, Saint-Jean (FR); Julie Lebas, Toulouse (FR)

(21) Appl. No.: 16/051,143

(22) Filed: Jul. 31, 2018

(30) Foreign Application Priority Data
Aug. 3, 2017 (FR) 1757453

(51) Int. Cl. G05D 1/10; G08G 5/00

(52) U.S. Cl. CPC G05D 1/104; B64C 23/06; G08G 5/0008; G08G 5/0078

(57) ABSTRACT

Method and device for monitoring the position of a following aircraft with respect to a leading aircraft during a formation flight. The device includes a module for determining a position of the leading aircraft based on a flight parameter coming from a first source, a module for determining a position of the following aircraft based on a flight parameter coming from another first source, modules for determining first and second relative positions of the following aircraft with respect to the leading aircraft based on flight parameters coming from second sources separate from the first sources, a module for comparing the first and second relative positions, and a module for transmitting, depending on the result of the comparison, to a control unit of the following aircraft, a control order either for keeping the following aircraft in an optimum position or for bringing it into a safety position.

### CROSS-REFERENCE TO RELATED APPLICATION

This patent application claims priority to French patent application FR 17 57453, filed on Aug. 3, 2017, the entire disclosure of which is incorporated by reference herein.

### TECHNICAL FIELD

The disclosure herein relates to a method and to a device for monitoring the position of a following aircraft with respect to a leading aircraft during a formation flight.

### BACKGROUND

A formation flight comprises at least two aircraft, in particular transport planes, namely a leading aircraft (or leader), and one or more following aircraft. The following aircraft fly following the aircraft that they are directly following (namely the leading aircraft or another following aircraft) in such a way as to maintain a constant spacing between them. In one particular application, in particular when cruising, the aircraft fly behind one another at the same flight level, with the same heading and the same speed. There may also be provision to apply speed control orders to the following aircraft, which orders are such that they allow the following aircraft to have the same position, the same speed and the same acceleration as the leading aircraft had at given past periods.

A formation flight requires perfect knowledge of the relative positions of the aircraft with respect to one another. To this end, accurate aircraft position determination systems exist, such as the cooperative monitoring system using automatic dependent surveillance-broadcasting (ADS-B) technology. However, the accuracy that is afforded is not satisfactory.

### SUMMARY

An aim of the disclosure herein is to mitigate these drawbacks by proposing a method and a device that make it possible to monitor the position of a following aircraft.

To this end, the disclosure herein relates to a method for monitoring the position of an aircraft, termed following aircraft, with respect to vortices generated by an aircraft, termed leading aircraft, in front of the following aircraft, the leading and following aircraft flying in formation.

According to the disclosure herein, the method comprises:

a preliminary step consisting of or comprising bringing and keeping the following aircraft in what is termed an optimum position, in which the following aircraft flying in formation benefits from effects of at least one of the vortices generated by the leading aircraft;

a first position determination step, implemented by a first position determination module, consisting of or comprising determining a position of the leading aircraft on the basis of at least one flight parameter coming from a first information source of the leading aircraft;

a second position determination step, implemented by a second position determination module, consisting of or comprising determining a position of the following aircraft on the basis of at least one flight parameter coming from a first information source of the following aircraft;

a first relative position determination step, implemented by a first relative position module, consisting of or comprising determining a first relative position of the following aircraft with respect to the leading aircraft on the basis of the position of the leading aircraft and of the position of the following aircraft;

a second relative position determination step, implemented by a second relative position module, consisting of or comprising determining a second relative position of the following aircraft with respect to the leading aircraft on the basis of at least one flight parameter coming from a second information source of the leading aircraft and from a second information source of the following aircraft, the second information sources being separate from the first information sources;

a comparison step, implemented by a comparison module, consisting of or comprising comparing the first relative position and the second relative position;

a validation step, implemented by a validation module, consisting of or comprising transmitting, to a control unit of the following aircraft, a signal representative of a control order for performing at least one of the following actions:

keeping the following aircraft in the optimum position, if the first relative position and the second relative position are substantially equal,

bringing the following aircraft into what is termed a safety position, in which the following aircraft is not subjected to effects of the vortices generated by the leading aircraft, if the first relative position and the second relative position are different.

Thus, by virtue of determining the relative position of the following aircraft with respect to the leading aircraft on the basis of two separate sources, it is possible to verify with certainty the relative position between the two aircraft. If there is an inconsistency between the relative position calculated on the basis of a first source and the relative position calculated on the basis of the second source, the following aircraft is brought into what is termed a safety position, in which it is not subjected to effects of the vortices generated by the leading aircraft.

In the context of the disclosure herein, the safety position is such that, in a first embodiment, the following aircraft continues to fly in formation, whereas, in a second embodiment, the formation flight is broken for this following aircraft. Preferably, the safety position is determined using a vortex transport model.

Furthermore, the first position determination step is preceded by a first transmission step, implemented by a first transmission module, consisting of or comprising transmitting the flight parameter(s) from the first information source of the leading aircraft to the first position determination module, the flight parameter(s) being transmitted by way of a first communication link.

Additionally, the second relative position determination step is preceded by a second transmission step, implemented by a second transmission module, consisting of or comprising transmitting the flight parameter(s) from the second information source of the leading aircraft to the second relative position determination module, the flight parameter(s) being transmitted by way of a second communication link different from the first communication link.

Furthermore, the position of the follower aircraft, determined at the second position determination step, corresponds to a so-called safety position, in which the follower aircraft is not subjected to vortex effects generated by the leading aircraft while remaining in formation flight, the safety position being determined using a vortex transport model.

In addition, the position of the follower aircraft, determined at the second position determination step, corresponds to a so-called optimum position, in which the follower aircraft flying in formation benefits from the effects of at least one of the vortices generated by the leading aircraft.

According to one particular feature, the second relative position determination step consists in or comprises determining the second longitudinal relative position of the following aircraft with respect to the leading aircraft, the second relative position determination step comprising at least the following sub-steps:

a sub-step of determining the difference between a speed of the leading aircraft and a speed of the following aircraft, the speed of the leading aircraft coming from the second information source of the leading aircraft, the speed of the following aircraft coming from the second information source of the following aircraft,

a sub-step of integrating, over time, a function dependent on the difference determined in the determination sub-step.

According to one particular feature, the second relative position determination step consists in or comprises determining the second lateral relative position of the following aircraft with respect to the leading aircraft, the second relative position determination step consisting of or comprising determining the lateral relative position on the basis of the integration of a function dependent on:

a roll angle and/or a yaw angle and/or a heading of the leading aircraft coming from the second information source of the leading aircraft,

a roll angle and/or a yaw angle and/or a heading of the following aircraft and the speed of the following aircraft coming from the second information source of the following aircraft.

The disclosure herein also relates to a device for monitoring the position of an aircraft, termed following aircraft, with respect to vortices generated by an aircraft, termed leading aircraft, in front of the following aircraft, the leading and following aircraft flying in formation, the following aircraft being brought and kept in what is termed an optimum position, in which the following aircraft flying in formation benefits from effects of at least one of the vortices generated by the leading aircraft.

According to the disclosure herein, the device includes:

a first position determination module, configured to determine a position of the leading aircraft on the basis of at least one flight parameter coming from a first information source of the leading aircraft;

a second position determination module, configured to determine a position of the following aircraft on the basis of at least one flight parameter coming from a first information source of the following aircraft;

a first relative position determination module, configured to determine a first relative position of the following aircraft with respect to the leading aircraft on the basis of the position of the leading aircraft and of the position of the following aircraft;

a second relative position determination module, configured to determine a second relative position of the following aircraft with respect to the leading aircraft on the basis of at least one flight parameter coming from a second information source of the leading aircraft and from a second information source of the following aircraft, the second information sources being separate from the first information sources;

a comparison module, configured to compare the first relative position and the second relative position;

a validation module, configured to transmit, to a control unit of the following aircraft, a signal representative of a control order for performing at least one of the following actions:

keeping the following aircraft in the optimum position, if the first relative position and the second relative position are substantially equal,

bringing the following aircraft into what is termed a safety position, in which the following aircraft is not subjected to effects of the vortices generated by the leading aircraft, if the first relative position and the second relative position are different.

Furthermore, the first position determination module is configured to receive the flight parameter(s) from the first information source of the leading aircraft from a first transmission module, configured to transmit the flight parameter(s) from the first information source of the leading aircraft to the first position determination module, the flight parameter(s) being transmitted by way of a first communication link.

Additionally, the second relative position determination module is configured to receive the flight parameter(s) from the second information source of the leading aircraft from a second transmission module, configured to transmit the flight parameter(s) from the second information source of the leading aircraft to the second relative position determination module, the flight parameter(s) being transmitted by way of a second communication link separate from the first communication link.

According to one particular feature, the second relative position determination module is configured to determine the second longitudinal relative position of the following aircraft with respect to the leading aircraft, the second relative position determination module being configured to:

determine the difference between the speed of the leading aircraft and the speed of the following aircraft, the speed of the leading aircraft coming from the second information source of the leading aircraft, the speed of the following aircraft coming from the second information source of the following aircraft,

calculate an integration, over time, of a function dependent on the difference.

According to another particular feature, the second relative position determination module is configured to determine the second lateral relative position of the following aircraft with respect to the leading aircraft, the second relative position determination module being configured to determine the lateral relative position on the basis of the integration of a function dependent on:

a roll angle and/or a yaw angle and/or a heading of the leading aircraft coming from the second information source of the leading aircraft,

a roll angle and/or a yaw angle and/or a heading of the following aircraft and the speed of the following aircraft coming from the second information source of the following aircraft.

The disclosure herein also relates to an aircraft, in particular a transport plane, including a device for monitoring the position of a following aircraft with respect to vortices generated by a leading aircraft, in front of the following aircraft, during a formation flight such as described above.

### BRIEF DESCRIPTION OF THE DRAWINGS

The disclosure herein, with its features and advantages, will become more clearly apparent upon reading the description given with reference to the appended, example drawings, in which:

FIG. 1 schematically shows the monitoring device;

FIG. 2 schematically shows the monitoring method; and

FIG. 3 is a schematic depiction of a formation flight, showing a leading aircraft generating vortices and two possible positions for a following aircraft with respect to these vortices.

### DETAILED DESCRIPTION

The description hereinafter will make reference to the figures cited above.

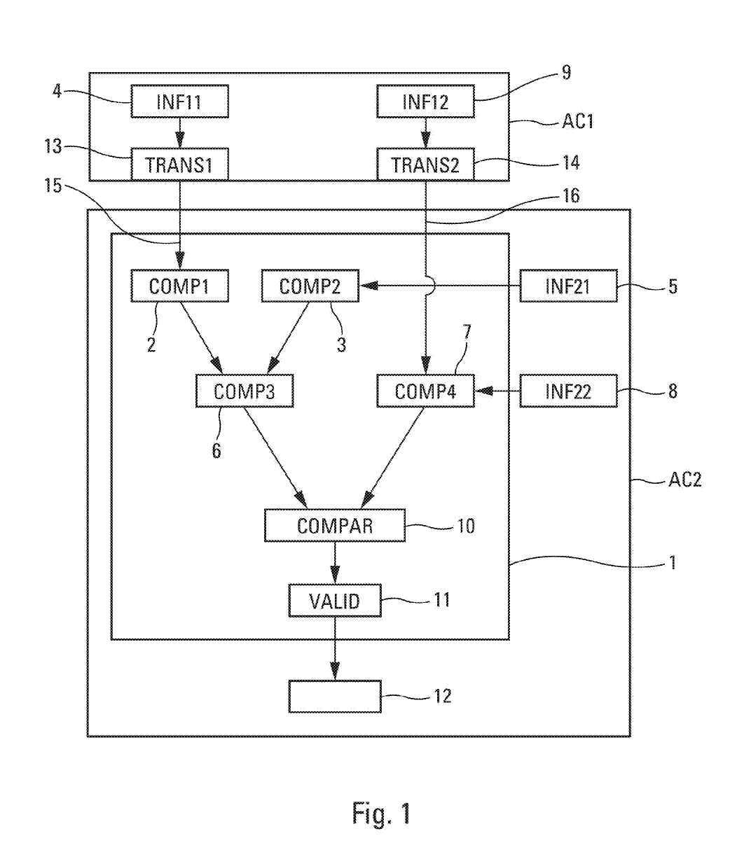

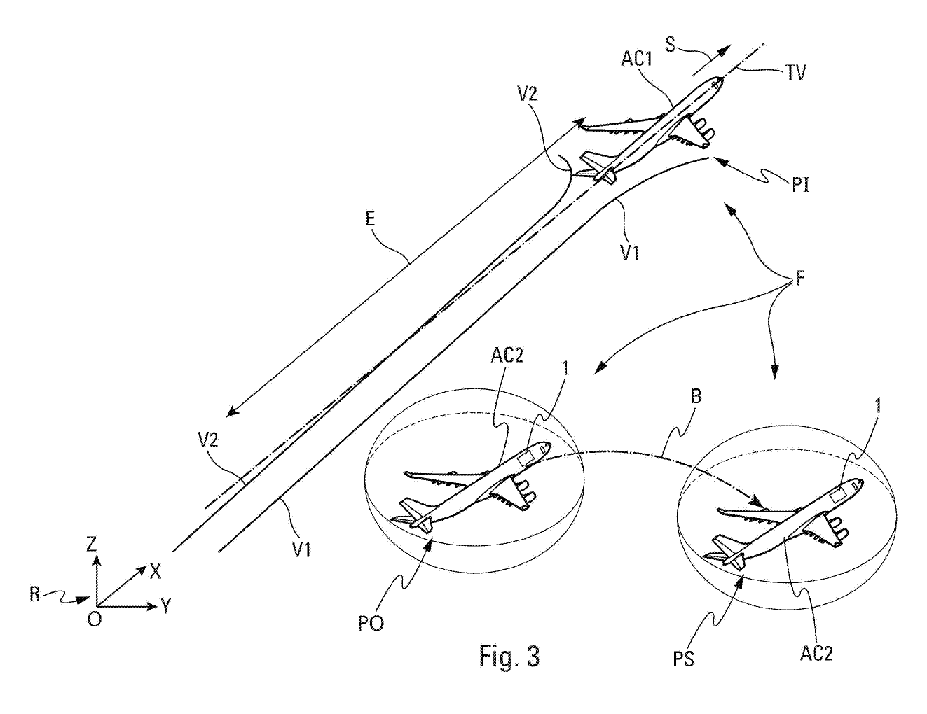

The device 1 for monitoring the path of an aircraft, termed following aircraft AC2, with respect to vortices generated by an aircraft, termed leading aircraft AC1, in front of the following aircraft, is illustrated schematically in FIG. 1. The following and leading aircraft are flying in formation. The device 1 is on board the following aircraft AC2, as shown in FIG. 3. In one particular embodiment, the device 1 forms part of a formation flight management unit (not shown specifically) that is on board the following aircraft AC2. Such a unit is configured to manage the formation flight at least for the following aircraft AC2.

The formation F comprises the leading aircraft AC1 and one or more following aircraft, namely a single following aircraft AC2 in the example of FIG. 3, which follow(s) the leading aircraft AC1 (situated at a position PI) in such a way as to keep a constant spacing E between them. In one particular application, in particular when cruising, the aircraft AC1 and AC2 fly behind one another at the same flight level, with the same heading and the same speed.

Furthermore, the following aircraft AC2 is slightly laterally offset with respect to the path TV followed by the leading aircraft AC1, so as to be situated in what is termed an optimum position PO for benefiting from the effects of vortices V1, V2 generated by the leading aircraft AC1, as explained below.

These vortices V1 and V2 start from each of its wings on account of the pressure difference between the lower surface and the upper surface of the wing, and of the downward deflection of the air flow that results therefrom. These vortices are counter-rotating vortices and are characterized by a wind field that rises overall outside of the vortices and that falls overall between the vortices. Starting from the wings, the vortices tend first of all to move closer to one another, and then to maintain a more or less constant distance from one another while at the same time losing altitude with respect to the altitude at which they were generated. On account of this configuration of the vortices, it is beneficial, for the following aircraft that is following the leading aircraft generating the vortices, to be brought into the optimum position PO where it is able to exploit the updraughts so as to reduce its fuel consumption. The optimum position PO may be determined using a vortex signature model.

To facilitate the description, FIG. 3 shows an orthonormal reference frame R, formed from three axes (or directions) X, Y and Z that are orthogonal to one another, which are such that:

X is the longitudinal axis of the fuselage of the leading aircraft AC1 oriented positively in the direction of travel S of the leading aircraft AC1;

Z is a vertical axis that forms, with the X-axis, a plane corresponding to the vertical plane of symmetry of the leading aircraft AC1; and

Y is a transverse axis that is orthogonal to the X- and Z-axes.

According to the disclosure herein, the device 1 includes:

a position determination module COMP1 2 (COMP for ‘computational module’ in English), configured to determine a position of the leading aircraft AC1 on the basis of at least one flight parameter coming from an information source INF11 (INF for ‘information source’ in English) 4 of the leading aircraft AC1;

a position determination module COMP2 3, configured to determine a position of the following aircraft AC2 on the basis of at least one flight parameter coming from an information source INF21 5 of the following aircraft AC2;

a relative position module COMP3 6, configured to determine a first relative position of the following aircraft AC2 with respect to the leading aircraft AC1 on the basis of the position of the leading aircraft AC1 and of the position of the following aircraft AC2;

a relative position module COMP4 7, configured to determine a second relative position of the following aircraft AC2 with respect to the leading aircraft AC1 on the basis of at least one flight parameter coming from an information source INF12 9 of the leading aircraft AC1 and from an information source INF22 8 of the following aircraft AC2, the information sources 8 and 9 being separate from the information sources 4 and 5.

The information source 4 of the leading aircraft AC1 may correspond to a satellite geopositioning system on board the leading aircraft AC1, for example a GPS (for ‘global positioning system’ in English) system. The information source 5 of the following aircraft AC2 may also correspond to a satellite geopositioning system on board the following aircraft AC2.

The information source 9 of the leading aircraft AC1 may correspond to a system on board the leading aircraft AC1 that provides information regarding the inertial references of the leading aircraft AC1 and regarding aerodynamic data of the leading aircraft AC1. For example, the on-board system may correspond to an ADIRU (for ‘air data inertial reference unit’ in English) system. The information source 8 of the following aircraft AC2 may also correspond to an ADIRU system on board the following aircraft AC2.

The device 1 also includes:

a comparison module COMPAR (COMPAR for ‘comparison module’ in English) 10, configured to compare the first relative position and the second relative position; and

a validation module VALID (VALID for ‘validation module’ in English) 11, configured to transmit, to a control unit 12 of the following aircraft AC2, a signal representative of a control order for performing at least one of the following actions:

keeping the following aircraft AC2 in the optimum position PO (in which it benefits from the effects of vortices V1, V2 generated by the leading aircraft AC1), if the first relative position and the second relative position are substantially equal (to within a predetermined margin),

bringing the following aircraft AC2 into what is termed a safety position PS, in which the following aircraft AC2 is not subjected to effects of the vortices V1, V2 generated by the leading aircraft AC1, if the first relative position and the second relative position are different.

The safety position PS is such that, in a first embodiment, the following aircraft AC2 continues to fly in formation, whereas, in a second embodiment, the formation flight is broken for this following aircraft AC2. The safety position PS may be determined using a vortex transport model.

The control unit 12 comprises all of the usual structure or means necessary to manually or automatically pilot the following aircraft AC2. This control unit 12 is not described further in the following description.

Thus, during the formation flight F, in a normal situation, and as long as it remains possible, the following aircraft AC2 is kept in the optimum position PO where it benefits both from the formation flight F and from the positive effects of the vortex V1.

When made necessary by the monitoring, the following aircraft AC2 is brought (swiftly) into the safety position PS, as illustrated by an arrow B in FIG. 3, with (depending on the embodiment) or without the formation flight F being broken.

According to one embodiment, the first position determination module 2 is configured to receive the flight parameter(s) from the first information source 4 of the leading aircraft AC1 from a first transmission module TRANS1 (TRANS for ‘transmission module’ in English) 13 that is configured to transmit the flight parameter(s) from the information source 4 of the leading aircraft AC1 to the first position determination module 2. The flight parameter(s) are transmitted by way of a first communication link 15. This communication link 15 may be part of a cooperative monitoring system using automatic dependent surveillance-broadcasting (ADS-B) technology. This technology is based on the transmission, in Mode S, which is one mode from among the aeronautical transponder interrogation modes on the frequency 1090 MHz, of a message containing a certain number of parameters of the aircraft.

Advantageously, the second relative position determination module 7 is configured to receive the flight parameter(s) from the second information source 9 of the leading aircraft AC1 from a second transmission module TRANS2 14, configured to transmit the flight parameter(s) from the information source 9 of the leading aircraft AC1 to the relative position determination module 7, the flight parameter(s) being transmitted by way of a second communication link 16. The communication link 16 is separate from the communication link 15. This communication system 16 may be part of an enhanced surveillance system (EHS) also operating in Mode S.

Other communication links may be used as communication links 15 and 16 that are separate from one another.

For example, the position of the following aircraft AC2, determined by the position determination module 3, corresponds to a so-called safety PS position, in which the follower aircraft AC2 is not subjected to the effects of the V1 vortices, V2 generated by the leading aircraft AC1 while remaining in formation flight F. The security position can be determined using a vortex transport model.

Likewise, the position of the follower aircraft AC2, determined by the position determination module 3, can correspond to a so-called optimal position PO, in which the aircraft AC2 flying in formation benefits from effects of at least 1 one of the vortices V1, V2 generated by the leading aircraft AC1. The optimum position PO can be determined using a vortex signature model. Thus, during the formation flight F, in the normal situation, and as long as it remains possible, the follower aircraft AC2 can be kept in the optimum position PO where it benefits from both the formation flight F and the positive effects of the flight. V1 vortex.

When a particular predetermined event occurs, if necessary, the follower aircraft AC2 can be brought quickly to the safety position PS, as illustrated by an arrow B in FIG. 3, without the formation flight F being broken.

In one embodiment, the relative position determination module 7 is configured to determine the second longitudinal relative position of the following aircraft AC2 with respect to the leading aircraft AC1.

To this end, the relative position determination module 7 is configured to:

determine the difference between a speed of the leading aircraft AC1 and a speed of the following aircraft AC2,

calculate an integration, over time, of a function dependent on the difference.

The speed of the leading aircraft AC1 comes from the information source 9 of the leading aircraft AC1. The speed of the following aircraft AC2 comes from the information source 8 of the following aircraft AC2.

Each of these speeds (of the leading aircraft AC1 and of the following aircraft AC2) may correspond to an air speed or a ground speed. Advantageously, the result of the integration of the function also comprises a constant of integration corresponding to a slow drift on account of the low frequency of the communication link 16.

According to one embodiment, the relative position determination module 7 is configured to determine the second lateral relative position of the following aircraft AC2 with respect to the leading aircraft AC1.

To this end, the relative position determination module 7 is configured to determine the lateral relative position on the basis of the integration of a function dependent on:
a roll angle and/or a yaw angle and/or a heading of the leading aircraft AC1 coming from the information source 9 of the leading aircraft AC1,
a roll angle and/or a yaw angle and/or a heading of the following aircraft and the speed of the following aircraft AC2 coming from the information source 8 of the following aircraft AC2.

Advantageously, the result of the integration of the function also comprises a constant of integration corresponding to a slow drift on account of the low frequency of the communication link 16.

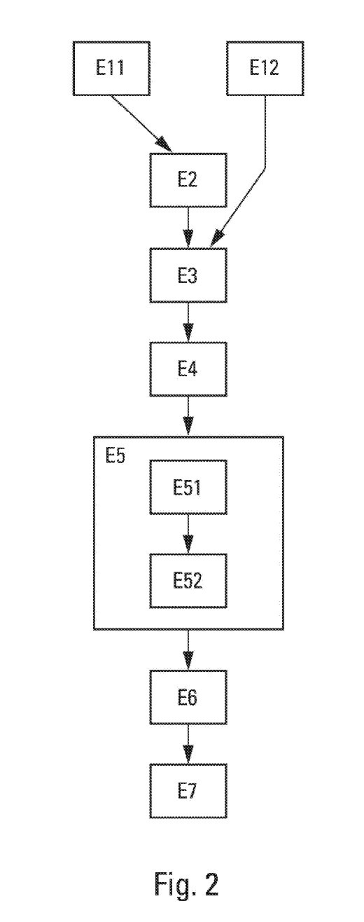

The method for monitoring the position of a following aircraft AC2, with respect to vortices V1, V2 generated by a leading aircraft AC1, is illustrated schematically in FIG. 2. The following aircraft AC2 and the leading aircraft AC1 are flying in formation, and the following aircraft AC2 is in the optimum position PO, into which it has been brought in a step prior to the steps shown in FIG. 2.

The method includes the following steps:

a position determination step E2, implemented by the position determination module 2, consisting of or comprising determining a position of the leading aircraft AC1 on the basis of at least one flight parameter coming from the information source 4 of the leading aircraft AC1;

a position determination step E3, implemented by the position determination module 3, consisting of or comprising determining a position of the following aircraft AC2 on the basis of at least one flight parameter coming from the information source 5 of the following aircraft AC2;

a relative position determination step E4, implemented by the relative position module 6, consisting of or comprising determining a first relative position of the following aircraft AC2 with respect to the leading aircraft AC1 on the basis of the position of the leading aircraft AC1 and of the position of the following aircraft AC2;

a relative position determination step E5, implemented by the relative position module 7, consisting of or comprising determining a second relative position of the following aircraft AC2 with respect to the leading aircraft AC1 on the basis of at least one flight parameter coming from the information source 9 of the leading aircraft AC1 and from the information source 8 of the following aircraft AC2, the information sources 8 and 9 being separate from the information sources 4 and 5;

a comparison step E6, implemented by the comparison module 10, consisting of or comprising comparing the first relative position and the second relative position;

a validation step E7, implemented by the validation module 11, consisting of or comprising transmitting, to the control unit 12 of the following aircraft AC2, a signal representative of a control order for performing at least one of the following actions:

keeping the following aircraft AC2 in the optimum position PO (in which it benefits from the effects of vortices V1, V2 generated by the leading aircraft AC1), if the first relative position (calculated in step E4) and the second relative position (calculated in step E5) are substantially equal,

bringing the following aircraft AC2 into the safety position PS (with or without breakage of the formation flight), in which the following aircraft AC2 is not subjected to effects of the vortices V1, V2 generated by the leading aircraft AC1, if the first relative position (calculated in step E4) and the second relative position (calculated in step E5) are different.

The position determination step E2 may be preceded by a transmission step E11, implemented by the transmission module 13, consisting of or comprising transmitting the flight parameter(s) from the information source 4 of the leading aircraft AC1 to the position determination module 2. The flight parameter(s) are transmitted by way of the communication link 15.

The relative position determination step E5 may be preceded by a transmission step E12, implemented by the transmission module 14, consisting of or comprising transmitting the flight parameter(s) from the information source 9 of the leading aircraft AC1 to the relative position determination module 7. The flight parameter(s) are transmitted by way of the communication link 16, separate from the communication link 15.

The relative position determination step E5 may consist in or comprise determining the second longitudinal relative position of the following aircraft AC2 with respect to the leading aircraft AC1, the relative position determination step E5 comprising at least the following sub-steps:

a sub-step E51 of determining the difference between a speed of the leading aircraft AC1 and a speed of the following aircraft AC2, the speed of the leading aircraft AC1 coming from the information source 9 of the leading aircraft AC1, the speed of the following aircraft AC2 coming from the information source 8 of the following aircraft AC2,

a sub-step E52 of integrating, over time, a function dependent on the difference determined in the determination sub-step E51.

The relative position determination step E5 may consist in or comprise determining the second lateral relative position of the following aircraft AC2 with respect to the leading aircraft AC1, the relative position determination step E5 consisting of or comprising determining the lateral relative position on the basis of the integration of a function dependent on:

a roll angle and/or a yaw angle and/or a heading of the leading aircraft AC1 coming from the information source 9 of the leading aircraft AC1,

a roll angle and/or a yaw angle and/or a heading of the following aircraft AC2 and the speed of the following aircraft AC2 coming from the information source 8 of the following aircraft AC2.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring a position of a following aircraft, with respect to vortices generated by a leading aircraft, in front of the following aircraft, the leading and following aircraft flying in formation, the method comprising:
a preliminary step comprising bringing and keeping the following aircraft in an optimum position, in which the following aircraft flying in formation benefits from effects of at least one of the vortices generated by the leading aircraft;
a first position determination step, implemented by a first position determination module, comprising determining a position of the leading aircraft on a basis of at least one flight parameter coming from a first information source of the leading aircraft;
a second position determination step, implemented by a second position determination module, comprising determining a position of the following aircraft on a basis of at least one flight parameter coming from a first information source of the following aircraft;
a first relative position determination step, implemented by a first relative position module, comprising determining a first relative position of the following aircraft with respect to the leading aircraft on a basis of position of the leading aircraft and of position of the following aircraft;
a second relative position determination step, implemented by a second relative position module, comprising determining a second relative position of the following aircraft with respect to the leading aircraft on a basis of at least one flight parameter coming from a second information source of the leading aircraft and from a second information source of the following aircraft, the second information sources being separate from the first information sources;
a comparison step, implemented by a comparison module, comprising comparing the first relative position and the second relative position; and
a validation step, implemented by a validation module, comprising transmitting, to a control unit of the following aircraft, a signal representative of a control order for performing at least one of:
keeping the following aircraft in the optimum position, if the first relative position and the second relative position are substantially equal,
bringing the following aircraft into a safety position, in which the following aircraft is not subjected to effects of the vortices generated by the leading aircraft, if the first relative position and the second relative position are different.

2. The method according to claim 1, wherein the first position determination step is preceded by a first transmission step, implemented by a first transmission module, comprising transmitting flight parameter(s) from the first information source of the leading aircraft to the first position determination module, the flight parameter(s) being transmitted by a first communication link.

3. The method according to claim 1, wherein the second relative position determination step is preceded by a second transmission step, implemented by a second transmission module, comprising transmitting the flight parameter(s) from the second information source of the leading aircraft to the second relative position determination module, the flight parameter(s) being transmitted by a second communication link separate from the first communication link.

4. The method according to claim 1, wherein the safety position is such that the following aircraft continues to fly in formation.

5. The method according to claim 1, wherein the safety position is such that the following aircraft breaks the formation flight.

6. The method according to claim 1, wherein the second relative position determination step comprises determining the second longitudinal relative position of the following aircraft with respect to the leading aircraft, the second relative position determination step comprising at least the following sub-steps:
a sub-step of determining difference between a speed of the leading aircraft and speed of the following aircraft, the speed of the leading aircraft coming from the second information source of the leading aircraft, the speed of the following aircraft coming from the second information source of the following aircraft (AC2); and
a sub-step of integrating, over time, a function dependent on the difference determined in the determination sub-step.

7. The method according to claim 1, wherein the second relative position determination step comprises determining a second lateral relative position of the following aircraft with respect to the leading aircraft, the second relative position determination step comprising determining the lateral relative position on a basis of integration of a function dependent on:
a roll angle and/or a yaw angle and/or a heading of the leading aircraft coming from the second information source of the leading aircraft,
a roll angle and/or a yaw angle and/or a heading of the following aircraft and speed of the following aircraft coming from the second information source of the following aircraft.

8. A device for monitoring position of a following aircraft, with respect to vortices generated by a leading aircraft, in front of the following aircraft, the leading and following aircraft flying in formation, the following aircraft being brought and kept in an optimum position, in which the following aircraft flying in formation benefits from effects of at least one of the vortices generated by the leading aircraft, the device comprising:
a first position determination module configured to determine a position of the leading aircraft on a basis of at least one flight parameter coming from a first information source of the leading aircraft;
a second position determination module configured to determine a position of the following aircraft on a basis of at least one flight parameter coming from a first information source of the following aircraft;
a first relative position determination module, configured to determine a first relative position of the following aircraft with respect to the leading aircraft on a basis of position of the leading aircraft and of position of the following aircraft;
a second relative position determination module configured to determine a second relative position of the following aircraft with respect to the leading aircraft on a basis of at least one flight parameter coming from a second information source of the leading aircraft and from a second information source of the following aircraft, the second information sources being separate from the first information sources;
a comparison module configured to compare the first relative position and the second relative position;
a validation module configured to transmit, to a control unit of the following aircraft, a signal representative of a control order for performing at least one of:
keeping the following aircraft in the optimum position, if the first relative position and the second relative position are substantially equal,
bringing the following aircraft into a safety position, in which the following aircraft is not subjected to effects of the vortices generated by the leading aircraft, if the first relative position and the second relative position are different.

9. The device according to claim 8,
wherein the first position determination module is configured to receive the flight parameter(s) from the first information source of the leading aircraft from a first transmission module, configured to transmit the flight parameter(s) from the first information source of the leading aircraft to the first position determination module, the flight parameter(s) being transmitted by way of a first communication link.

10. The device according to claim 9, wherein the second relative position determination module is configured to receive the flight parameter(s) from the second information source of the leading aircraft from a second transmission module, configured to transmit the flight parameter(s) from the second information source of the leading aircraft to the second relative position determination module, the flight parameter(s) being transmitted by a second communication link separate from the first communication link.

11. The device according to claim 10, wherein the second relative position determination module is configured to determine a second longitudinal relative position of the following aircraft with respect to the leading aircraft, the second relative position determination module being configured to:
determine a difference between speed of the leading aircraft and speed of the following aircraft, the speed of the leading aircraft coming from the second information source of the leading aircraft, the speed of the following aircraft coming from the second information source of the following aircraft,
calculate an integration, over time, of a function dependent on the difference.

12. The device according to claim 10, wherein the second relative position determination module is configured to determine a second lateral relative position of the following aircraft with respect to the leading aircraft, the second relative position determination module being configured to determine the lateral relative position on a basis of integration of a function dependent on:
a roll angle and/or a yaw angle and/or a heading of the leading aircraft coming from the second information source of the leading aircraft,
a roll angle and/or a yaw angle and/or a heading of the following aircraft and the speed of the following aircraft coming from the second information source of the following aircraft.

13. An aircraft comprising a device for monitoring position of a following aircraft, with respect to vortices generated by a leading aircraft, in front of the following aircraft, the leading and following aircraft flying in formation, the following aircraft being brought and kept in an optimum position, in which the following aircraft flying in formation benefits from effects of at least one of the vortices generated by the leading aircraft, the device comprising:
a first position determination module configured to determine a position of the leading aircraft on a basis of at least one flight parameter coming from a first information source of the leading aircraft;
a second position determination module configured to determine a position of the following aircraft on a basis of at least one flight parameter coming from a first information source of the following aircraft;
a first relative position determination module, configured to determine a first relative position of the following aircraft with respect to the leading aircraft on a basis of position of the leading aircraft and of position of the following aircraft;
a second relative position determination module configured to determine a second relative position of the following aircraft with respect to the leading aircraft on a basis of at least one flight parameter coming from a second information source of the leading aircraft and from a second information source of the following aircraft, the second information sources being separate from the first information sources;
a comparison module configured to compare the first relative position and the second relative position;
a validation module configured to transmit, to a control unit of the following aircraft, a signal representative of a control order for performing at least one of:
keeping the following aircraft in the optimum position, if the first relative position and the second relative position are substantially equal,
bringing the following aircraft into a safety position, in which the following aircraft is not subjected to effects of the vortices generated by the leading aircraft, if the first relative position and the second relative position are different.
